(19) United States
(12) Patent Application Publication
(10) Pub. No.: US 2013/0092878 A1
(43) Pub. Date: Apr. 18, 2013

(54) Thermoplastic based electronic conductive inks and method of making the same

(71) Applicant: Steven Xiao, St-Laurent (CA)

(72) Inventor: Steven Xiao, St-Laurent (CA)

(73) Assignee: 1-MATERIAL INC, ST-LARENT (CA)

(21) Appl. No.: 13/317,331

(22) Filed: Oct. 17, 2011

(51) Int. Cl. C09D 11/00; H01B 1/12

(52) U.S. Cl. 252/500; 524/609

(57) ABSTRACT

This invention discloses a composition of thermoplastic based electronic conductive inks, more specifically electronic conductive inks containing chemically functioned thermoplastic resins and poly(3,4-ethylenedioxythiophene). This invention also teaches the method of making the same and electronic devices making from the same.

### FIELD OF THE INVENTION

This invention relates to a composition of thermoplastic based electronic conductive inks, more specifically electronic conductive inks containing chemically functioned thermoplastic resins and poly(3,4-ethylenedioxythiophene). It also relates to the method of making the same and electronic devices making from the same.

### BACKGROUND OF THE INVENTION

Thermoplastic resins such as the copolymer of ethylene-styrene (ES) and butadiene-styrene (BS, SBS) possessing the advantage of both rubbers and plastics are being used in wide applications including coating, automobiles and variety of engineering plastics. They are insulator in nature, and neither conducting ions nor conducting electrons. Chemically, these insulting polymers can be functionalized to introduce ionic groups such as SO₄²⁻, PO₄³⁻, NH₄⁺, N(CH₃)₄⁺ . . . to make them ionic conducting, thus they can be used as poly-electrolytes, more commonly as ion-exchange resins. However, it has not been reported to make these thermoplastic resins themselves electronic conducting yet in the prior art.

On another hand, the potential applications for electronic conducting polymers are legion, including anti-statics, Electromagnetic Interference/Radio Frequency Interference (EMI/RFI) shielding, Indium Tin Oxide (ITO) replacement, Organic Light Emitting Diodes (OLED) for lighting and displays, organic photovoltaics (OPV), sensors, smart fabrics and organic thin-film transistors. Poly(3,4-ethylenedioxythiophene) (PEDOT), which was invented in 1988 by Bayer AG [U.S. Pat. No. 4,987,042], is still the most used conducting polymer commercially available driven by its high conductivity, easy process-ability, and ambient stability.

Practically, PEDOT is used in a form of polyelectrolyte complex (PEC) containing poly(styrenesulfonic acid) (PSS) as a counter-ion, where PEDOT/PSS polyelectrolyte forming a stable aqueous dispersion [U.S. Pat. No. 5,300,575 (Bayer AG)]. Such a polyelectrolyte dispersion can be applied to selected substrates to make the desired thin film. Being a highly conjugated polymer complex, PEDOT/PSS exhibits many favorable characteristics including good thermal stability, high conductivity, high transparency, and easy processing [U.S. Pat. No. 7,338,621 and U.S. Pat. No. 7,378,039] in making thin film devices. However, its performance and applicability is still limited due to inherent drawbacks. First, the PEDOT/PSS aqueous dispersions have undesirable low pH level (acidic) which potentially impact the thin film devices consisting of it; Secondly, the pristine films casted from PEDOT/PSS are generally weak and brittle and exhibit poor mechanical properties; Thirdly, PEDOT/PSS aqueous dispersion doesn't have good wet-ability to plastic substrates which cause the difficulty in making a good film on plastic substrates; and indeed even a film of PEDOT/PSS is formed on a plastic substrate, this coated film would mostly exhibit poor adhesion on plastic substrates due to the extensive conjugation in the main chain structure of the polymer resulting in increased chain stiffness and exfoliation of the film.

Great demands and continuous efforts have been made to obviate or at least mitigate the aforementioned problems associated with PEDOT/PSS system. For example, US patent publication number US2006/0818816 A1 disclosed that by replacing the water in the PEDOT/PSS dispersions with some alcohol such as ethylene glycol, the film formability and even the conductivity were much improved. Another US patent publication number 2007/0131910 A1 disclosed that by mixing some binders such as polyester dispersions with PEDOT/PSS, the adhesion on plastic substrates could be improved as well. Reviewing the prior art, one may find many techniques have been explored, and each technique may provide a solution to solve one and a few of many problems associated with PEDOT/PSS system, however there is not an appropriate technique which can render these drawbacks of the current PEDOT/PSS system in a broad scope. More specifically, there is not existing a technique in the prior art which can reduce the acidic nature of the PEDOT/PSS and to increase the film flexibility and durability at the same time to maintain its electronic properties. It is the objective of this invention to provide such an art.

In summary, the objective of the present invention is therefore to provide a composition of thermoplastic based electronic conductive inks, more specifically electronic conductive inks containing poly(partly sulfonated styrene-alkene) copolymer/poly(3,4-ethylenedioxythiophene) complex. The resultant inks have excellent film formability and the films cast from which exhibit good mechanical properties and desirable conductivity.

### SUMMARY OF THE INVENTION

The present invention provides a process for the oxidative polymerization of 3,4-ethylenedioxythiophene monomer to form the conducting polymer PEDOT. The process comprises carrying out polymerization in a mixture of water and selected solvents miscible with water in the presence of Poly(partly Sulfonated Styrene-Alkene) copolymers, referred as PSSA hereafter in this invention.

This invention also provides the novel Poly(partly Sulfonated Styrene-Alkene) copolymer/Poly(3,4-EthyleneDiOxyThiophene) complex, referred as PSSA/PEDOT in this invention and an aqueous or non-aqueous dispersion of this complex.

This invention also provides a solution-process-able ink containing the above-disclosed an aqueous or non-aqueous dispersion of PSSA/PEDOT

This invention also teaches the methods in using the invented solution-process-able PEDOT/PSSA inks to make organic electronic devices.

The invention further discloses that the preferable PSSA is partly sulfonated ethylene-styrene random interpolymer (S-ESI, Formula I) or partly sulfonated styrene/ethylene-butylene/styrene triblock copolymer (S-SEBS, Formula II):

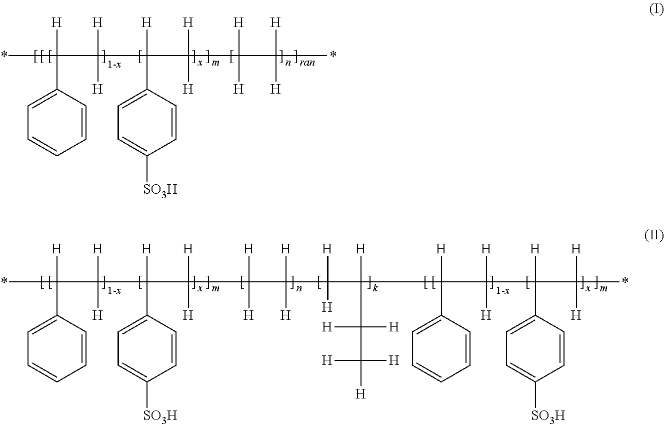

Where m, n, k are independent integrals greater than 1, and the ratio of n to m (n/m) is in the range of 1-20, with a most preferred range of 5-10. x represents the degree of sulfonation of styrene unit, and it is a fraction greater than zero and small than one, preferable in the range of 0.2-0.6.

### DETAILED DESCRIPTION OF THE INVENTION

The PSSA copolymers including S-ESI and S-SEBS are commercially available from 1-Material Inc. The complex of PSSA copolymer and poly(3,4-ethylenedioxythiophene) (PEDOT) is formed by oxidative polymerization of 3,4-ethylenedioxythiophene monomer in a mixed dispersing liquid in the presence of the PSSA.

The sulfonate functionality of the PSSA copolymer is used in the range of 0.1-5.0 mmol/g, with a most preferred range of 1.0-3.0 mmol/g. More specifically, the degree of the sulfonation (x) as defined in Formula (I) or Formula (II) is preferably in the range of 0.2-0.6. The polymer is firstly dissolved or dispersed in a mixed dispersing liquid and it is totally dissolved or self-assembled into micelles depending on the composition of the mixed dispersing liquid.

The suitable oxidizing agents include commercially available ammonium and alkali persulfates, and H₂O₂/inorganic acid. In addition, catalytic quantities of metal ions such as iron(III) salts may be used as oxidizing agents.

The basic dispersing liquid is water and the co-dispersing liquid miscible with water may be added. Examples of suitable co-dispersing liquids include methanol, ethanol, n-propanol, isopropanol, t-butanol, dimethylformamide, N-methylpyrrolidone, dimethyl sulfoxide, and the combinations thereof.

Typically, a single chain or micelle dispersion of PSSA and an oxidizing agent and a catalytic oxidizing agent are mixed and stirred with bubbling of an inert gas such as argon, nitrogen through the reaction medium. Then an organic solution such as ethanol solution of 3,4-ethylenedioxythiophene monomer is added into the reaction system. The polymerization time may vary depending on the temperature, the oxidizing agent used, and the composition of dispersing medium. Typically, polymerization is allowed to proceed at ambient temperature, about 25° C., for about 5 to 48 hours.

The product of the polymerization reaction is an ion pair complex of PSSA anion and positively charged PEDOT, referred to herein as the Poly(partly Sulfonated Styrene-Alkene)-copolymer-poly(3,4-ethylenedioxythiophene) complex, PSSA/PEDOT. The PSSA:PEDOT weight ratio is in the range of 0.5-5.0, with a most preferred range of 1.0-3.0.

The produced complex PSSA/PEDOT can be separated by filtration, where the filters with different pore sizes may be chosen depending on the particle sizes of the complex. Then it is washed with large amount water or water miscible solvents. This above process is repeated a few times. Then, a black blue gel can be obtained with 90-95% content of water. The gel can be dried under reduced pressure and a wet-dry solid with 50-90% content of water can be finally obtained.

The PSSA/PEDOT gel or solid is typically considered a raw material and is most often formulated into an ink or coating for plastics, glass and other substrates. The PSSA/PEDOT formulations typically consist of: PSSA/PEDOT gel, solvent, conductivity enhancers, binders, surfactants, de-foams, cross-linkers, and adhesion promoters. The formulation may contain all of these substances, but not necessarily has to. The components needed depend on the application and the desired effects. The solvent is usually a mixture of water and water-miscible solvents. The suitable water-miscible solvents include: alcohols (e.g. Methanol, Ethanol, Isopropanol, N-propanol), ketones (e.g. Acetone and Methylethylketone), THF (Tetrahydrofuran), DMF (N,N-Dimethylformamide), and DMSO (Dimethylsulfoxide). The conductivity enhancers are high boiling, polar compounds, for example: Glycerine, Ethylene glycol, N-Methylpyrrolidone, N,N-dimethylacetamide, DMF (N,N-Dimethylformamide), and DMSO (Dimethylsulfoxide). The binder must be waterborne such as Polyvinyl alcohols and Polyester dispersions.

The formulated PSSA/PEDOT inks can be applied to a substrate to form a conductive thin film, which is now used in the fabrication of electro-opto semiconducting device such as OLED (Organic light emitting diode), OPV (Organic photovolatatic), OTFT (Organic thin film transistor), in EMS (electromagnetic shielding) coating and anti-static coating and anticorrosion coating. In the fabrication of organic semiconducting device, PSSA/PEDOT inks can be applied onto the ITO anode to render the roughness and work-function of ITO electrode and to assist hole transporting properties (referred as the hole transport layer-HTL).

### EXAMPLES

The invention will now be described in more detail with reference to the following examples. However, it should be understood that these examples are given for the purpose of illustration only and are not intended to limit the scope of the present invention.

### Example 1

### Preparation of S-ESI/PEDOT Complex

2.50 g of S-ESI was added into a mixture of 25 g iso-propanol and 225 g H₂O at room temperature. Keep stirring for 24 hrs until a homogeneous solution (light yellow) obtained. A selected amount (exampled in Table 1) of saturated NaCl solution (25 wt.%) was added into the above solution to adjust the concentration of [Na⁺] and micelle solutions of S-ESI with different sizes were formed. The micelle solution was filtered through a glass microfiber filter as the start reaction media. After bubbling argon through the media for 30 minutes, a mixture aqueous solution of NH₄Fe(SO₄)₂.12H₂O and (NH₄)₂S₂O₈ was added (exampled in the Table 1). Then, an iso-propanol solution of EDOT was added into the mixture. The reaction solution was kept stirring at room temperature (R.T.) for 5 hours. An aqueous solution of (NH₄)₂S₂O₈ was added into the reaction solution and kept stirring at R.T. for another 15 hours. A dark blue suspension was obtained at this stage. The solid in the suspension was the complex of PEDOT and S-ESI and it was separated from the suspension by centrifugation or filtration. The solid complex was purified by washing with water and iso-propanol. A dark blue gel containing 80-90 wt. % of H₂O can be finally obtained after purification by centrifugation or filtration.

TABLE 1
Receipt Examples for Preparation of S-ESI/PEDOT Complex

| | ESI | EDOT | | (NH₄)₂S₂O₈ (g) | | Water | isopropanol | NaCl |
|---|---|---|---|---|---|---|---|---|
| Batch | weight | weight | NH₄Fe(SO₄)₂•12H₂O | initially | added | weight | weight | weight |
| No.# | (g) | (g) | weight (g) | added | after 5 h | (g) | (g) | (g) |
| 1M-11 | 2.5 | 1.0 | 0.1 | 2.0 | 0.3 | 270 | 30 | 5.5 |
| 1M-12 | 2.5 | 1.0 | 0.03 | 2.0 | 0.3 | 270 | 30 | 5.5 |
| 1M-13 | 2.5 | 1.0 | 0.03 | 2.0 | 0.3 | 240 | 30 | 0 |
| 1M-14 | 2.5 | 2.0 | 0.05 | 4.0 | 0.6 | 270 | 30 | 5.5 |
| 1M-15 | 2.5 | 2.0 | 0.05 | 4.0 | 0.3 | 240 | 30 | 0 |
| 1M-16 | 2.5 | 2.0 | 0.5 | 5.0 | 0 | 240 | 50 | 0 |
| 1M-17 | 2.5 | 2.0 | 0.5 | 2.5 | 2.5 | 240 | 50 | 0 |
| 1M-18 | 2.5 | 2.0 | 0.5 g H₂O₂ (50% wt.), | | | 270 | 30 | 0 |
| | | | 4.5 g of HCl (36% wt.) | | | | | |
| 1M-19 | 2.5 | 2.0 | 0.5 | 0 | 5.0 | 240 | 50 | 0 |

### Example 2

### Preparation of S-SEBS/PEDOT Complex

2.50 g of S-SEBS was added into a mixture of 25 g iso-propanol and 225 g H₂O at room temperature. Keep stirring for 24 hrs until a homogeneous solution (light yellow) was obtained. 22 g of NaCl solution (25 wt. %) was added into the above solution to adjust the concentration of [Na⁺] and micelle solutions of S-SEBS were formed. The micelle solution was filtered through a glass microfiber filter as the start reaction media. After bubbling argon through the media for 30 minutes, a mixture aqueous solution of NH₄Fe(SO4)₂.12H₂O (0.5 g) and (NH₄)₂S₂O₈ (5.0 g) was added. Then, an iso-propanol solution of EDOT was added into the mixture. The reaction solution was kept stirring at room temperature (R.T.) for 5 hours. An aqueous solution of (NH₄)₂S₂O₈ (0.5 g) was added into the reaction solution and kept stirring at R.T. for another 15 hours. A dark blue suspension was finally obtained. The solid in the suspension was the complex of PEDOT and S-ESI and it was separated from the suspension by centrifugation or filtration. The solid complex was purified by washing with water and iso-propanol. A dark blue gel containing 80-90 wt. % of H₂O can be obtained after purification by centrifugation or filtration.

### Example 3

### Examples of PSSA/PEDOT Dispersions

A certain amount of PSSA/PEDOT gel from Example 1 or 2 was added into a clean glass vessel and a certain amount of H₂O or a mixture of H₂O and water-miscible solvents was added then. The mixture was stirred vigorously with a high shear mixer and ultra-sonicated to obtain the final samples with 0.5-3.0 wt. % of PSSA/PEDOT (as exampled in Table 2).

TABLE 2
Receipt Examples of PSSA/PEDOT dispersions

| | | | Solvent | | | Particle |
|---|---|---|---|---|---|---|
| Sample | Batch | PEDOT/ESI | H₂O | Isopropanol | Others | size |
| No.# | No.#^{(a)} | (wt. %) | (wt. %) | (wt. %) | (wt. %) | (nm)^{(c)} |
| PEDOT/PSS | Aldrich^{(b)} | 1.3 | 100 | 0 | 0 | 200 |
| | 483095 | | | | | |
| PEDOT-1M11 | 1M-12 | 1.5 | 93.5 | 0 | DMSO 5.0 | 300 |
| PEDOT-1M12 | 1M-12 | 1.5 | 28.5 | 65.0 | DMSO 5.0 | 570 |
| PEDOT-1M13 | 1M-11 | 1.5 | 93.5 | 0 | DMSO 5.0 | 260 |
| PEDOT-1M14 | 1M-11 | 1.5 | 47.0 | 46.5 | DMSO 5.0 | 380 |
| PEDOT-1M15 | 1M-13 | 1.5 | 93.5 | 0 | DMSO 5.0 | 700 |
| PEDOT-1M16 | 1M-13 | 1.5 | 28.5 | 65.0 | DMSO 5.0 | 250 |
| PEDOT-1M17 | 1M-14 | 1.5 | 93.5 | 0 | DMSO 5.0 | |
| PEDOT-1M18 | 1M-14 | 1.5 | 28.5 | 65.0 | DMSO 5.0 | |
| PEDOT-1M19 | 1M-15 | 1.5 | 93.5 | 0 | DMSO 5.0 | |
| PEDOT-1M20 | 1M-15 | 1.5 | 28.5 | 65.0 | DMSO 5.0 | |
| PEDOT-1M21 | 1M-16 | 1.5 | 78.5 | 15.0 | DMSO 5.0 | |
| PEDOT-1M22 | 1M-16 | 1.5 | 38.5 | 55.0 | DMSO 5.0 | |
| PEDOT-1M23 | 1M-16 | 1.0 | 29.0 | 29.0 | EtOH 40.0 | |
| PEDOT-1M24 | 1M-16 | 1.0 | 29.0 | 29.0 | DMF 40.0 | |
| PEDOT-1M25 | 1M-17 | 1.5 | | | DMSO 5.0 | |
| PEDOT-1M26 | 1M-17 | 1.5 | | | DMSO 5.0 | |
| PEDOT-1M27 | IM-17 | 1.5 | 100 | 0 | 0 | |
| PEDOT-1M28 | 1M-17 | 1.5 | 20 | 80 | 0 | |
| PEDOT-1M29 | 1M-23 | 1.0 | 0 | 0 | THF 100 | |
| PEDOT-1M30 | 1M-23 | 1.0 | 0 | 100 | 0 | |

^{(a)}Batch numbers are these listed in Table-1
^{(b)}Reference sample was purchased from Aldrich Company, Catalogue # 483095
^{(c)}It was measured by dynamic light scattering.

### Example 4

### Conductivity of Selected PSSA/PEDOT Dispersions

An appropriate way to measure the conductivity of PSSA/PEDOT complex is to deposit the material as a thin and homogeneous layer on a flat substrate by using deposition techniques such as spin-coating. The thickness of the layers should be in the range of 50-500 nm. The layer thickness can be determined by scratching the film off the substrate with a razor blade and scanning the stylus of a mechanical or optical profile meter across the scratch. The sheet resistance can then be measured with conventional four-point probes.

For the conventional four-point probe method, the glass slides were used as the substrate. The glass substrate was cleaned thoroughly with detergent, rinsed with de-ionized (DI) water, and then successively ultra-sonicated in acetone, isopropanol and DI water for 30 minutes each. The substrate was then dried with a nitrogen flow and baked at 150° C. for 20 minute. Then, the PSSA/PEDOT samples from Example 3 were passed through the 0.45 μm PVDF membrane filters individually and spun-cast on the top of the glass substrates under an ambient environment. To be dehydrated, the substrates were then baked at 120° C. for 1 hour.

The resistance value was measured by using the 4-point probe technique. The measurement was performed at several spots on the same film. For example, a film casted from the PSSA/PEDOT dispersion sample of PEDOT/1M-21 listed in Table 2, was found to have a sheet resistance of 35 kΩ/□.

Alternatively, the sheet resistance can be determined with a multimeter by measuring the impedance between parallel contacts. The contacts can be deposited onto the PSSA/PEDOT layer for example with silver paint or by evaporating metals through a shadow mask. In case of simple two-point measurements the resistance of lead-in wires and contacts have to be negligible. For this method, the glass slides were also used as the substrates. The samples of PSSA/PEDOT dispersions were filtered through a 0.45 μm PVDF membrane filters. Spin coating was performed at 2000 rpm for 30 seconds. After spin coating, the films were annealed at 150° C. for 15 minutes. Aluminum electrodes were then deposited on the surface about 0.7 mm apart. From this method, the sheet resistance of a film casted from sample of PEDOT-1M-12 was found to be 33 kΩ/□. Considering the thickness of the film was 120 nm, one therefore can calculate the conductivity of this exampled PEDOT-1M12 film to be 2.5 S/cm.

### Example 5

### Electronic Devices and Performance of these Devices Made from Selected PSSA/PEDOT Dispersions

In this example, bulk heterojunction organic photovoltaic devices were fabricated as a multilayer structure sandwiched between a transparent anode and a cathode. The anode consists of a photolithographically patterned indium-tin-oxide (ITO) on glass substrate. The patterned ITO substrate was cleaned by ultrasonic treatment sequentially in detergent, deionized water and acetone followed by rinsing in isopropanol. Subsequently, thin layers of PSSA/PEDOT (samples PEDOT 1M11 and 1M12) (50 nm) were spun-cast at 8000 rpm for 30 seconds onto the patterned ITO/glass substrates, and then the obtained wet films were annealed at 140° C. for 10 minutes. The samples were then transferred into a nitrogen-filled glove box to complete the device fabrication. The active layer of the devices was prepared from a blend of electron donor polymer PTB7 and electron acceptor PCBM, both from 1-Material Inc. The thin PTB7/PCBM film (250 nm) was spun-cast with a 1:1 ratio from their solution in dichlorobenzene (3% by weight) onto the PSSA/PEDOT coated ITO/glass substrate at 400 rpm for 30 seconds. The films were allowed to dry slowly in an inert atmosphere before deposit the cathode consisting of 1 nm of LiF followed by 100 nm aluminum through a shadow mask. The completed devices were annealed at 90° C. for 10 minutes before characterization.

The device photovoltaic characteristics were extracted from the current versus voltage curves measured using a simulated AM 1.5 Global solar illumination with ˜100 mW/cm² integrated intensity. Examples of performance parameters for selected PSSA/PEDOT dispersions were listed in Table-4. It clearly demonstrated the invented PSSA/PEDOT can be used in the fabrication of organic semi-conducting devices.

Table 4, Photovolatic characteristics of devices made from PSSA/PEDOT dispersions exampled in this invention.

| Device Sample | Isc (mA) | Voc (V) | FF | PCE (%) |
|---|---|---|---|---|
| PEDOT-1M11 | 0.84147 | 0.4839 | 0.325416 | 1.325052 |
| PEDOT-1M12 | 0.6787 | 0.2356 | 0.226534 | 0.362231 |

REFERENCE CITED

| | | |
|---|---|---|
| U.S. Pat. No. | 4,987,042 | January 1991 |
| U.S. Pat. No. | 5,300,575 | April 1994 |
| U.S. Pat. No. | 7,338,621 | March 2008 |
| U.S. Pat. No. | 7,378,039 | May 2008 |
| US Patent Publication | 2006/0818816 | April 2006 |
| US Patent Publication | 2007/0131910 | January 2007 |

What is claimed:

1. A complex of PSSA/PEDOT, where PSSA is Poly(partly Sulfonated Styrene-Alkene) copolymer, and PEDOT is poly(3,4-EthyleneDiOxyThiophene).

2. The PSSA in the claim 1 is partly sulfonated ethylene-styrene randon interpolymer (S-ESI, Formula I) 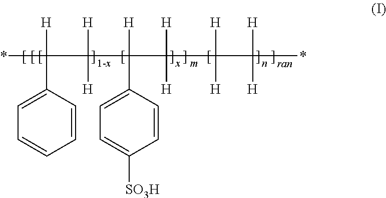
Where m and n are independent integrals being greater than 1, and the ratio of n to m (n/m) is in the range of 1-20; x represents the degree of sulfonation of styrene unit, and it is a fraction greater than zero and small than one.

3. The PSSA in the claim 1 is partly sulfonated styrene/ethylene-butylene/styrene triblock copolymer (S-SEBS, Formula II): 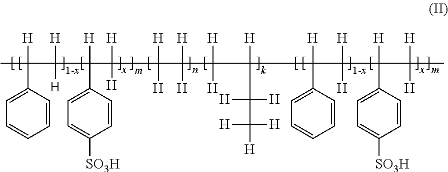
Where m, n, k are independent integrals greater than 1, and the ratio of n to m(n/m) is in the range of 1-20; x represents the degree of sulfonation of styrene unit, and it is a fraction greater than zero and small than one.

4. The complex of PSSA/PEDOT claimed in claim 1 is an aqueous dispersion

5. The complex of PSSA/PEDOT claimed in claim 1 is an organic solvent dispersion.

6. The complex of PSSA/PEDOT claimed in claim 1 is a dispersion in a combined media containing water and organic solvent.

7. The complex of PSSA/PEDOT claimed in claim 1 is used to coat onto a substrate to make a conducting thin film, and such a conducting film is functioned as antistatic layer, electromagnetic shielding, charge transporting layer in organic semiconductor devices.
